(19) United States
(12) Patent Application Publication
(10) Pub. No.: US 2025/0104155 A1
(43) Pub. Date: Mar. 27, 2025

(54) HOME SCORE DETERMINATION BASED UPON PROPERTY, SAFETY, WEATHER, CONNECTIVITY AND/OR OTHER SUBSCORES

(71) Applicant: STATE FARM MUTUAL AUTOMOBILE INSURANCE COMPANY, Bloomington, IL (US)

(72) Inventors: Amy L. Starr, Roswell, GA (US); Kami Lavallier, Knoxville, TN (US)

(21) Appl. No.: 18/656,848

(22) Filed: May 7, 2024

Related U.S. Application Data
(60) Provisional application No. 63/540,136, filed on Sep. 25, 2023.

(51) Int. Cl. G06Q 40/08

(52) U.S. Cl. CPC G06Q 40/08

(57) ABSTRACT

The following relates generally to smart home technology, home maintenance and upkeep, and home damage prevention and mitigation; and more specifically to generating and/or displaying home scores for a property. In some embodiments, one or more processors: retrieve attributes of a property; determine, from the attributes, (i) a property subscore, (ii) a safety subscore, (iii) a weather subscore, (iv) a connectivity subscore, and/or (v) a property insurance coverage subscore; generate an overall home score of the property based upon the subscores; and display (i) one or more of the home subscores, and (ii) the overall home score.

### CROSS REFERENCE TO RELATED APPLICATIONS

This application claims the benefit of U.S. Provisional Application No. 63/540,136, entitled “Home Score Determination Based Upon Property, Safety, Weather, Connectivity and/or Other Subscores” (filed Sep. 25, 2023), the entirety of which is incorporated by reference herein.

### FIELD

In general, the present embodiments relate to smart home technology, home maintenance and upkeep, and home damage prevention and mitigation. More specifically, the present embodiments relate to generating, updating, and/or displaying home scores for a property.

### BACKGROUND

Determining and presenting a home score (e.g., a score rating safety of a home, etc.) may be important to an insurance company, as well as homeowners. However, present systems for determining and/or displaying home scores and/or subscores may have certain drawbacks.

Conventional techniques may also have other ineffectiveness, insecurities, difficulties, inefficiencies, encumbrances, and/or additional drawbacks. The systems and methods disclosed herein may provide solutions to these and other problems.

### SUMMARY

The present embodiments may relate to, inter alia, smart home technology, home maintenance and upkeep, and home damage prevention and mitigation-including determining and/or displaying home scores and/or subscores. For example, a customer (or prospective customer) of an insurance company may be presented (e.g., on a display of a smartphone) with an overall home score, and/or a plurality of home subscores. The plurality of subscores may include a property subscore, a safety subscore, a weather subscore, a connectivity subscore, and/or a property insurance coverage subscore, etc. The system may offer recommendations for products to improve the overall home score, and/or any of the subscores. The system may also send alerts about home maintenance to be performed, such as to user's mobile devices over one or more wireless communication links.

In one aspect, a computer-implemented method for generating and/or displaying home scores for a property may be provided. The method may be implemented via one or more local or remote processors, sensors, transceivers, servers, memory units, augmented reality (AR) glasses or headsets, virtual reality (VR) headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) retrieving, by one or more processors, one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determining, by the one or more processors, one or more home subscores, wherein the one or more home subscores include (i) a property subscore, (ii) a safety subscore, (iii) a weather subscore, (iv) a connectivity subscore, and/or (v) a property insurance coverage subscore, and wherein the determining the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generating, by the one or more processors, the overall home score of the property based upon the one or more subscores; and/or (4) displaying, via the one or more processors: (i) one or more of the home subscores, and (ii) the overall home score. The method may include additional, fewer, or alternate actions, including those discussed elsewhere herein.

In another aspect, a computer system for generating and/or displaying home scores for a property may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer system may include one or more processors configured to: (1) retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generate the overall home score of the property based upon the one or more subscores; and/or (4) display: (i) one or more of the home subscores, and (ii) the overall home score. The computer system may include additional, less, or alternate functionality, including that discussed elsewhere herein.

In yet another aspect, a tangible, non-transitory computer-readable medium storing instructions for generating and/or displaying home scores may be provided. The instructions, when executed by one or more processors of a computing device, may cause the computing device to perform certain actions. The computing device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the tangible, non-transitory computer-readable medium may store instructions that, when executed by one or more processors of a computing device, cause the computing device to: (1) retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generate the overall home score of the property based upon the one or more subscores; and/or (4) display: (i) one or more of the home subscores, and (ii) the overall home score. The tangible, non-transitory computer-readable medium may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary home score system, according to one embodiment.

FIG. 2 depicts an exemplary introductory screen to a dedicated home (DHOME) app.

FIG. 3 depicts an exemplary screen including an overall home score, a connectivity subscore, and a property insurance subscore.

FIG. 4 depicts an exemplary table indicating information of safety attributes.

FIG. 5 depicts an exemplary matrix of smart smoke detectors indicating points that the smart smoke detectors increase the safety subscore by.

FIG. 6 depicts a combined block and logic diagram in which exemplary computer-implemented methods and systems for using ML to generate home score(s) and/or product recommendations are implemented, according to one embodiment.

FIG. 7 depicts a combined block and logic diagram in which exemplary computer-implemented methods and systems for training an ML chatbot model are implemented, according to one embodiment.

FIG. 8 depicts an exemplary computer-implemented method or implementation for determining one or more home scores.

FIG. 9 depicts an exemplary screen enabling a user to view checklists of different rooms for inventory items.

FIG. 10 depicts an exemplary screen including a checklist for bedroom inventory items.

FIG. 11 depicts an exemplary screen including an exemplary explanation of the connectivity subscore.

FIG. 12 depicts an exemplary screen including an alert that maintenance is due.

FIG. 13 depicts an exemplary screen recommending a product to a user.

### DETAILED DESCRIPTION

The present embodiments relate to, inter alia, determining and/or displaying home scores and/or subscores. For example, a customer (or prospective customer) of an insurance company may be presented (e.g., on a display of a smartphone) with an overall home score, and/or a plurality of home subscores. The plurality of subscores may include a property subscore, a safety subscore, a weather subscore, a connectivity subscore, and/or a property insurance coverage subscore, etc. The system may offer recommendations for products and/or services to purchase to improve the overall home score, and/or any of the subscores. The system may further send alerts about home maintenance that is recommended be performed.

### Exemplary Home Marketplace System

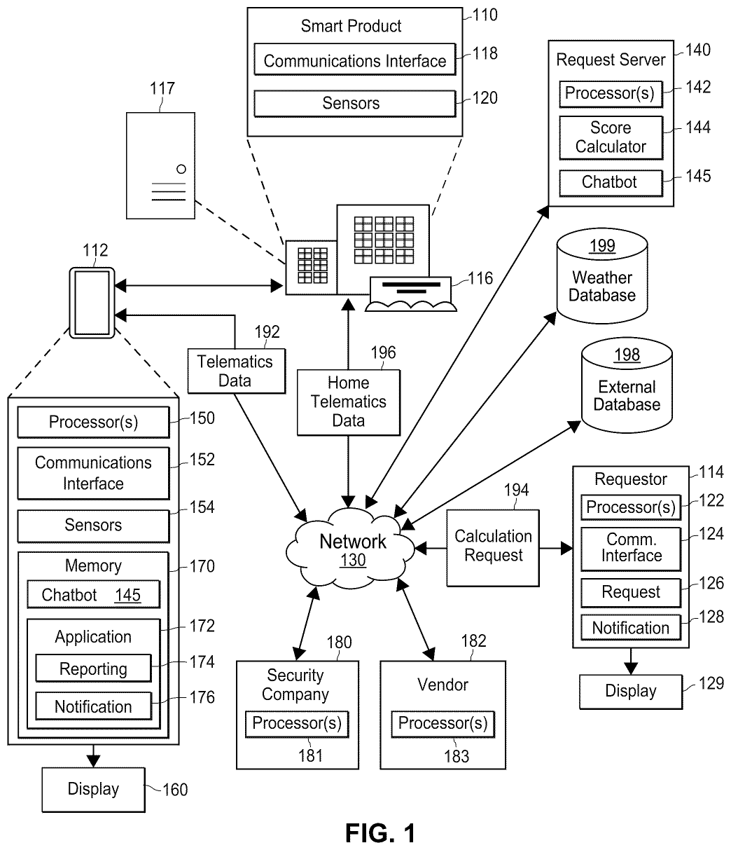

FIG. 1 depicts an exemplary home score and marketplace system 100. Depending on the embodiment, the exemplary system 100 may determine and/or display an overall home score, a plurality of home subscores, or any other similar home score for a user. It should be appreciated that an entity (e.g., requestor 114), such as an insurance company, may wish to determine and/or view any such overall home score, and/or plurality of home subscores.

Additionally, the property (e.g., a home or residence, such as property 116) and, more specifically, a computing device 117 associated with the property 116, a smart device 110 within the property 116, and/or one or more mobile devices may detect, gather, or store home data (e.g., home telematics data) associated with the functioning, operation, and/or evaluation of the property 116. The computing device 117 associated with the property 116 may transmit home telematics data in a communication 196 via the network 130 to a request server 140.

In some embodiments, the request server 140 may already store home data (e.g., home telematics data) and/or user data (e.g., user telematics data) in addition to any received home telematics data or user telematics data. Further, the request server 140 may use the home telematics data and/or user telematics data to evaluate and calculate/determine a home score for the property 116, or to train any machine learning algorithm as discussed herein. Additionally or alternatively, one or more mobile devices (e.g., mobile device 112) communicatively coupled to the computing device associated with the property 116 may transmit home telematics data and/or user telematics data in communication 192 to the request server 140 via the network 130.

The smart device 110 may include a processor, a set of one or several sensors 120, and/or a communications interface 118. In some embodiments, the smart device 110 may include single devices, such as a smart television, smart refrigerator, smart doorbell, or any other similar smart device. In further embodiments, the smart device 110 may include a network of devices, such as a security system, a lighting system, or any other similar series of devices communicating with one another. The set of sensors 120 may include, for example, a camera or series of cameras, a motion detector, a temperature sensor, an airflow sensor, a smoke detector, a carbon monoxide detector, or any similar sensor.

Although FIG. 1 depicts the set of sensors 120 inside the smart device 110, it is noted that the sensors 120 need not be internal components of the smart device 110. Rather, a property 116 may include any number of sensors in various locations, and the smart device 110 may receive data from these sensors during operation. In further embodiments, the computing device 117 associated with the property 116 may receive data from the sensors during operation. In still further embodiments, the computing device 117 associated with the property 116 may be the smart device 110.

The communications interface 118 may allow the smart device 110 to communicate with the mobile device 112, the sensors 120, and/or a computing device 117 associated with the property 116. The communications interface 118 may support wired or wireless communications, such as USB, Bluetooth, Wi-Fi Direct, Near Field Communication (NFC), etc. The communications interface 118 may allow the smart device 110 to communicate with various content providers, servers, etc., via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc. The processor may operate to format messages transmitted between the smart device 110 and the mobile device 112, sensors 120, and/or computing device 117 associated with the property 116; process data from the sensors 120; transmit communications to the request server 140; etc.

In some embodiments, the smart device 110 may collect the home telematics data using the sensors 120. Depending on the embodiment, the smart device may collect home telematics data regarding the usage and/or occupancy of the property 116. In some embodiments, the home telematics data may include data such as security camera data, electrical system data, plumbing data, appliance data, energy data, maintenance data, guest data, homeshare data, rental data, home use data, home occupancy data, home occupant data, renter data, home layout data (e.g., home structure, number of bedrooms, number of bathrooms, square footage, etc.), home characteristic data, and any other suitable data representative of property 116 occupancy and/or usage.

For instance, the home telematics data may include data gathered from motion sensors and/or images of the home from which it may be determined how many people occupy the property and the amount of time they each spend within the home. Additionally or alternatively, the home telematics data may include electricity usage data, water usage data, HVAC usage data (e.g., how often the furnace or air conditioner unit is on), and smart appliance data (e.g., how often the stove, oven, dish washer, or clothes washer is operated). The home telematics data may also include home occupant mobile device data or home guest mobile device data, such as GPS or other location data.

The user data (e.g., user telematics data) may include data from the user's mobile device, or other computing devices, such as smart glasses, wearables, smart watches, laptops, etc. The user data or user telematics data may include data associated with the movement of the user, such as GPS or other location data, and/or other sensor data, including camera data or images acquired via the mobile or other computing device. In some embodiments, the user data and/or user telematics data may include historical data related to the user, such as historical home data, historical claim data, historical accident data, etc. In further embodiments, the user data and/or user telematics data may include present and/or future data, such as expected home data when moving, projected claim data, projected accident data, etc. Depending on the embodiment, the historical user data and the present and/or future data may be related.

The user data or user telematics data may also include vehicle telematics data collected or otherwise generated by a vehicle telematics app installed and/or running on the user's mobile device or other computing device. For instance, the vehicle telematics data may include acceleration, braking, cornering, speed, and location data, and/or other data indicative of the user's driving behavior.

The user data or user telematics data may also include home telematics data collected or otherwise generated by a home telematics app installed and/or running on the user's mobile device or other computing device. For instance, a home telematics app may be in communication with a smart home controller and/or smart appliances or other smart devices situated about a home, and may collect data from the interconnected smart devices and/or smart home sensors. Depending on the embodiment, the user telematics data and/or the home telematics data may include information input by the user at a computing device or at another device associated with the user. In further embodiments, the user telematics data and/or the home telematics data may only be collected or otherwise generated after receiving a confirmation from the user, although the user may not directly input the data.

In some embodiments, the user data or user telematics data may include user-reported data obtained via an application (e.g., on the mobile device 112), website, email, phone call, etc. Depending on the embodiment, the user-reported data may include one or more answers to questions regarding a property 116 associated with the user. For example, the user-reported data may include answers regarding: a year the home was built, whether any components and/or systems (e.g., electrical, plumbing, foundation, etc.) have been replaced, when any components and/or systems have been replaced, how many stories the property has, whether the property has a basement, whether the basement is finished, a size range of the overall size of the property, a square footage of a building (e.g., as being, associated with, or part of the property), a subjective overall condition rating of the property, whether other people live on the property, how many people live on the property full time, how many people live on the property part-time, how many hours per day someone is typically on the property, any homeownership worries the user has (e.g., ability to afford repairs, ability to make repairs, ability to find someone to make repairs, general worry regarding unforeseen issues, etc.), frequency with which the user forgets to lock doors (e.g., days per week, days per month, etc.), frequency with which the user forgets to close windows (e.g., days per week, days per month, etc.), whether the user utilizes security mitigation devices (e.g., cameras, sensors, central monitored security system, connected smoke detectors, water sensors, electrical system monitors, etc.), whether the user has various disaster prevention items (e.g., a fire extinguisher, first aid kid, etc.), how the user handles home care and maintenance (e.g., do-it-yourself (DIY) style maintenance, hire a professional, differing depending on circumstance, etc.), a description of a maintenance schedule, any plans for structural changes (e.g., replacing roof, replacing windows, adding/changing floorplan, etc.), any plans for cosmetic changes (e.g., paint, replacing appliances, adding/changing carpeting, etc.), a level of satisfaction for care and maintenance of the property, whether any obstacles prevent the user from being satisfied with home care and maintenance (e.g., time, money, knowledge, resources, etc.), whether the user has had an insurance review recently (e.g., in the last month, in the last 6 months, in the last 12 months, etc.), and/or any other such datapoints.

Mobile device 112 may be associated with (e.g., in the possession of, configured to provide secure access to, etc.) a particular user, who may be an owner of a property, such as property 116. In further embodiments, the mobile device 112 may be associated with a potential homeowner, shopper, developer, or other such particular user. Mobile device 112 may be a personal computing device of that user, such as a smartphone, a tablet, smart glasses, smart headset (e.g., augmented realty, virtual reality, or extended reality headset or glasses), wearable, or any other suitable device or combination of devices (e.g., a smart watch plus a smartphone) with wireless communication capability. In the embodiment of FIG. 1, mobile device 112 may include a processor 150, a communications interface 152, sensors 154, a memory 170, and a display 160.

Processor 150 may include any suitable number of processors and/or processor types. Processor 150 may include one or more CPUs and one or more graphics processing units (GPUs), for example. Generally, processor 150 may be configured to execute software instructions stored in memory 170. Memory 170 may include one or more persistent memories (e.g., a hard drive and/or solid state memory) and may store one or more applications, including application 172.

The mobile device 112 may be communicatively coupled to the smart device 110, the sensors 120, and/or a computing device 117 associated with the property 116. For example, the mobile device 112 and the smart device 110, sensors 120, and/or computing device 117 associated with the property 116 may communicate via USB, Bluetooth, Wi-Fi Direct, Near Field Communication (NFC), etc. For example, the smart device 110 may send home telematics data, user telematics data, or other sensor data in the property 116 via communications interface 118 and the mobile device 112 may receive the home telematics data or other sensor data via communications interface 152. In other embodiments, mobile device 112 may obtain the home telematics data from the property 116 from sensors 154 within the mobile device 112.

Further still, mobile device 112 may obtain the home telematics data and/or user telematics data via a user interaction with a display 160 of the mobile device 112. For example, a user may take a photograph indicative of a property and/or input, at the display 160, information regarding characteristics indicative of potential hazards or other such information relevant to determining any of the scores. Scoring unit 174 may be configured to prompt a user to take a photograph or input information at the display 160. The mobile device 112 may then generate a communication that may include the home telematics data and/or user telematics data and may transmit the communication 192 to the request server 140 via communications interface 152.

In some embodiments, the application 172 may include or may be communicatively coupled to a home score application or website. In such embodiments, the request server 140 may obtain the home telematics data and/or user telematics data via stored data in the home score application or via a notification 176 in the application 172 granting the application 172 access to the home score application data.

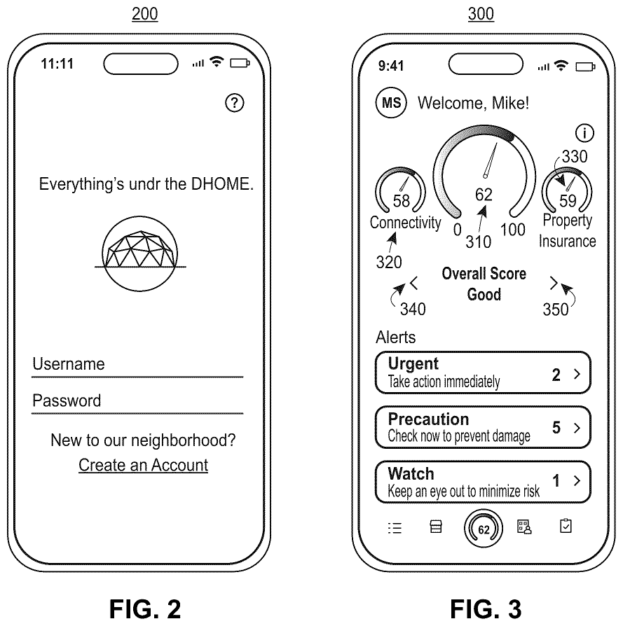

The application 172 may perform any suitable function. For example, the application 172 may: determine and/or display any of the home score and/or the subscores; provide recommendations for products to purchase to improve any of the home score(s); allow a user to purchase products; send alerts to the user regarding home maintenance; etc. In this regard, the application 172 may provide a comprehensive home app, which, in some embodiments, may be referred to as a Dedicated Home (DHOME) app, or as a Domestic Operations Management Ecosystem (DOME) app. FIG. 2 depicts an exemplary introductory screen 200 to such an app.

FIG. 3 depicts another exemplary display 300 that may be produced by the app 172. More particularly, the exemplary display 300 shows the overall home score 310, the connectivity subscore 320, and the property insurance subscore 330. In addition, the arrows 340, 350 allow the user to toggle between home scores.

Depending on the embodiment, a computing device 117 associated with the property 116 may obtain home telematics data for the property 116 indicative of environmental conditions, housing and/or construction conditions, location conditions, first responder conditions, or other similar metrics of home telematics data. The computing device 117 associated with the property 116 may obtain the home telematics data from one or more sensors 120 within the property 116. In other embodiments, the computing device 117 associated with the property 116 may obtain home telematics data through interfacing with a mobile device 112.

Depending on the embodiment, home telematics data may be indicative of both visible and invisible hazards to the property. For example, the home telematics data may include image data of the property 116 as well as internal diagnostic data on functionality of particular devices or components of the property 116. In another example, home telematics data may be used to determine that the property 116 and/or components of the property 116 are likely to require repair and/or replacement, and may lead to a potential risk or claim associated with the property 116.

In some embodiments, the home telematics data may include interpretations of raw sensor data, such as detecting an intruder event when a sensor detects motion during a particular time period. The computing device 117 associated with the property 116, mobile device 112, and/or smart device 110 may collect and transmit home telematics data to the request server 140 via the network 130 in real-time or at least near real-time at each time interval in which the system 100 collects home telematics data. In other embodiments, a component of the system 100 may collect a set of home telematics data at several time intervals over a time period (e.g., a day), and the smart device 110, computing device 117 associated with the property 116, and/or mobile device 112 may generate and transmit a communication which may include the set of home telematics data collected over the time period.

In addition, in some embodiments, the smart device 110, computing device 117 associated with the property 116, and/or mobile device 112 may generate and transmit communications periodically (e.g., every minute, every hour, every day), where each communication may include a different set of home telematics data and/or user telematics data collected over the most recent time period. In other embodiments, the smart device 110, computing device 117 associated with the property 116, and/or mobile device 112 may generate and transmit communications as the smart device 110, mobile device 112, and/or computing device 117 associated with the property 116 receive new home telematics data and/or user telematics data.

In further embodiments, a trusted party may collect and transmit the home telematics data and/or user telematics data, such as an evidence oracle. The evidence oracles may be devices connected to the internet that record and/or receive information about the physical environment around them, such as a smart device 110, a mobile device 112, sensors 120, a request server 140, etc. In further examples, the evidence oracles may be devices connected to sensors such as connected video cameras, motion sensors, environmental conditions sensors (e.g., measuring atmospheric pressure, humidity, etc.) as well as other Internet of Things (IoT) devices.

The data may be packaged into a communication, such as communication 192 or 196. The data from the evidence oracle may include a communication ID, an originator (identified by a cryptographic proof-of-identity, and/or a unique oracle ID), an evidence type, such as video and audio evidence, and a cryptographic hash of the evidence. In another embodiment, the evidence is not stored as a cryptographic hash, but may be directly accessible by an observer or other network participant.

Next, the smart device 110 and/or computing device 117 associated with the property 116 may generate a communication 196 including a representation of the home telematics data wherein the communication 196 is stored at the request server 140 and/or an external database 198.

In some embodiments, generating the communication 196 may include obtaining identity data for the smart device 110, computing device 117, and/or the property 116; obtaining identity data for the mobile device 112 in the property 116; and/or augmenting the communication 196 with the identity data for the smart device 110, the property 116, the computing device 117, and/or the mobile device 112. The communication 196 may include the home telematics data or a cryptographic hash value corresponding to the home telematics data.

In some embodiments, the mobile device 112 or the smart device 110 may transmit the home telematics data and/or user telematics data to a request server 140. The request server 140 may include a processor 142 and a memory that stores various applications for execution by the processor 142. For example, a score calculator 144 may obtain home telematics data for a property 116 and/or user telematics data for a user to analyze, calculate, and/or determine score(s) for a property 116 (e.g., the overall home score, any of the home subscores, etc.). The score calculator 144 may also use any of the scores to determine recommendations to improve any of the score(s), determine recommendations for vendors to sell items and/or provide services, etc.

In further embodiments, a requestor 114 may transmit a communication 194 including a score calculation request to the request server 140 via the network 130. Depending on the embodiment, the requestor may include one or more processors 122, a communications interface 124, a request module 126, a notification module 128, and a display 129. In some embodiments, each of the one or more processors 122, communications interface 124, request module 126, notification module 128, and display 129 may be similar to the components described above with regard to the mobile device 112.

Depending on the embodiment, the requestor 114 may be associated with a particular user, such as an insurance company, a shopper, a home shopping website and/or application, a home rental website and/or application, a construction company, a real estate company, an underwriting company, etc. In some embodiments, the requestor 114 may be associated with the same user as the request server 140. In other embodiments, the requestor 114 is associated with a different user than the request server 140. In some such embodiments, the request module 126 and/or notification module 128 may include or be part of a request application, such as an underwriting application, a shopping application, an insurance application, etc.

In some embodiments, the requestor 114 may transmit the communication 194 including a score request to the requestor 140 via the communications interface 124. In some such embodiments, the requestor 114 may request the score to use as an input to a rating model, an underwriting model, a claims generation model, or any other similarly suitable model. For example, the requestor 114 or a user (e.g., via the mobile device 112) may request the overall home score, the home subscores (e.g., the property subscore, the safety subscore, the weather subscore, the connectivity subscore, the property insurance coverage subscore, etc.), a self-risk score, an auto score, etc.

As will be discussed elsewhere herein, any of the scores may be determined by any suitable technique. For example, any of the scores may be determined via a machine learning model(s), which may be trained via any suitable technique. For instance, a machine learning model that determines the safety subscore may be trained using historical data at least in part from the security company 180, which includes one or more processors 181.

As also will be discussed elsewhere herein, the recommendations for vendors (such as vendor 182, which may include one or more processors 183) may be determined by any suitable technique. For instance, the recommendations may be determined via a lookup table, or via a machine learning model. The recommendations may allow a user to select from a plurality of vendors, thus creating an exemplary marketplace.

The weather database 199 may hold any suitable weather information. For example, the weather database may hold information of current or previous weather conditions (e.g., weather conditions of the area of the property 116, etc.). In some embodiments, the weather database 199 may also store weather attributes of the property 116.

Furthermore, although the exemplary system 100 illustrates only one of each of the components, any number of the example components are contemplated (e.g., any number of mobile devices, vendors, requestors, smart products, request servers security companies, computing devices, etc.).

Exemplary Determination of the Home Scores and/or Recommended Products

The home score(s) may be determined by any suitable technique. In this regard, the home scores may be determined with or without the use of machine learning.

In some embodiments, the property subscore, safety subscore, weather subscore, connectivity subscore, and/or property insurance coverage subscore may be determined by determining attribute(s) for each subscore. Subsequently, the overall home score may be determined by combining the subscore (e.g., by taking an average or weighted average of the subscores).

Said another way, in some variations, the property subscore, safety subscore, weather subscore, connectivity subscore, and/or property insurance coverage subscore may be determined based upon property attributes, safety attributes, weather attributes, connectivity attributes, and/or property insurance coverage attributes.

Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores.

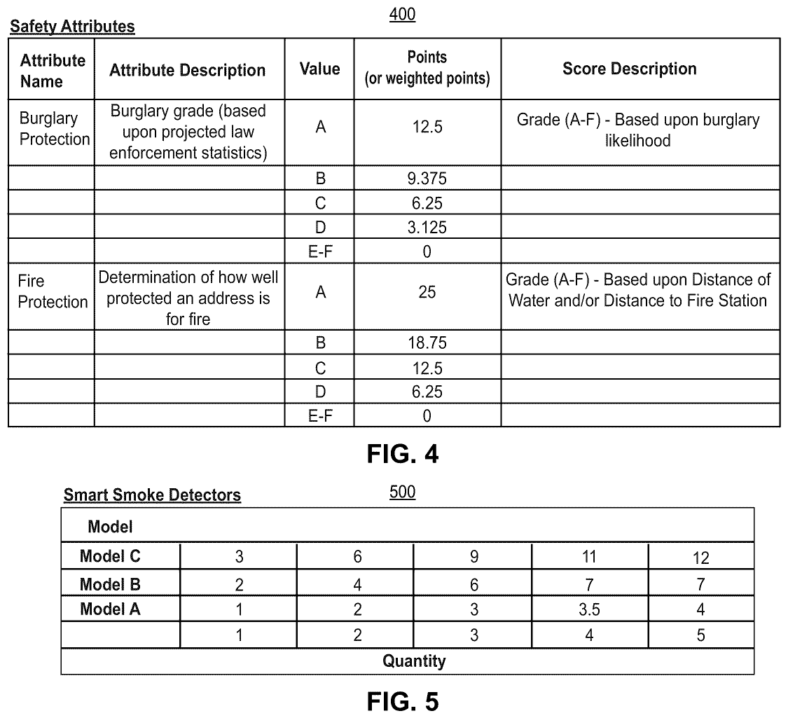

By way of exemplary illustration, FIG. 4 shows an exemplary table 400 indicating information of an exemplary safety attributes. More specifically, the illustrated example shows a burglary protection attribute and a fire protection attribute. The exemplary attributes may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points.

In some embodiments, when values are missing (e.g., NaN, etc.), they may be filled in with a neutral value. For instance, with respect to the exemplary attributes of FIG. 4, if any of the values corresponding to attributes with a grade (A-F) are missing, they may be filled in with a value of C. For example, if the burglary protection value is missing, it may be filled in with a value of C, and thus receive points or weighted points of 6.25.

In some implementations, the grades and/or categorical values may be assigned by a vendor evaluating the home 116. The assigned grades and/or categorical values may then be stored in a database, and/or sent directly to any other component in FIG. 1 (e.g., the request server 140, the requestor 114, the mobile device 112, the smart product 110, etc.).

Examples of the property attributes include: a property age attribute (e.g. a number of years ago that a house was built, etc.), a status of property structure attribute (e.g., under construction, construction completed, occupied, unoccupied, etc.), an efficiency of property structure attribute (e.g., how well insulated a property is, how water efficient the property is, etc.), a status of property systems attribute (e.g., a status indicating which systems are functioning properly, such as security systems, sprinkler systems, any smart home systems, etc.), and/or an efficiency of property systems attribute (e.g., how electrical efficient the home systems are, how water efficient the home systems are, a gas efficient the home systems are, etc.).

Examples of the safety attributes include a fire protection attribute, a burglary protection attribute, a water quality attribute, a tree overhang attribute, and/or an air quality attribute.

Examples of the weather attributes include a property weatherproofing attribute, a presence of resilient building materials attribute, and/or a presence of property weather alert systems attribute.

Examples of the connectivity attributes include a property network connection strength attribute, a property network connection speed attribute, and/or a smart home devices on the property network attribute.

Examples of the property insurance coverage attributes include: a property insurance policy types associated with the property attribute, an insurance coverage amount associated with the property attribute, insurance deductible amounts associated with the property attribute, and/or a home inventory associated with the property attribute (e.g., a home inventory created as described elsewhere herein, or created by any other suitable technique).

In some embodiments, the property insurance coverage attributes may further comprise information of the insured property or items; and/or a comparison between the coverage amount of the insured property or items and the value of the insured property or items. For instance, if the coverage amount is larger than the value of the insured property or items, this may lead to a higher property insurance coverage subscore. In contrast, if the coverage amount is less than the value of the insured property or items, this may lead to a lower property insurance coverage subscore. In some embodiments, the property insurance coverage attributes may include a value (e.g., similar to the value depicted in FIG. 4, etc.).

Additionally or alternatively, individual devices may affect a home score(s) by a specific amount (e.g., adding a smart smoke detector improves a safety subscore by 1 point; etc.). In addition, in some embodiments, each device affects the home score incrementally (e.g., each smart smoke detector added adds one point to the safety subscore, etc.). However, in some such embodiments, there is a maximum number of devices that may continue to improve the home score(s) (e.g., the first 5 smoke detectors each improve the safety subscore by 1 point, but the sixth does not improve the safety subscore). In some certain embodiments, the improvements are phased out (e.g., the first four smoke detectors each improve the safety subscore by 1 point, the next 3 smoke detectors improve the safety subscore by half a point, and the subsequent smoke detectors do not improve the safety subscore). Furthermore, different models of a device may have different impacts on the home score(s) (e.g., a basic model smart main water shut off valve improves a connectivity subscore by 2 points, and a more advanced model improves the connectivity subscore by 4 points). As such, the home score(s) may be affected by both the model and the quantity of the device.

To this end, the attribute may also comprise a matrix of devices. For example, for any of the subscores, there may be an attribute including device matrixes for particular devices. For instance, FIG. 5 depicts exemplary matrix 500 of smart smoke detectors indicating points that the smart smoke detectors increase the safety subscore by. The exemplary matrix 500 depicts both model and quantity of the device, with the numbers in the matrix indicating how the devices affect the safety subscore. For example, as illustrated, a safety subscore for a home with one model A smoke detector would get 1 point for the model A smoke detector. In another illustrated example, a safety subscore for a home with three model C smoke detectors would get 9 points for the smoke detectors.

Additionally or alternatively, the machine learning (ML) may be used to calculate the home score(s), as discussed further below.

### Exemplary ML Model

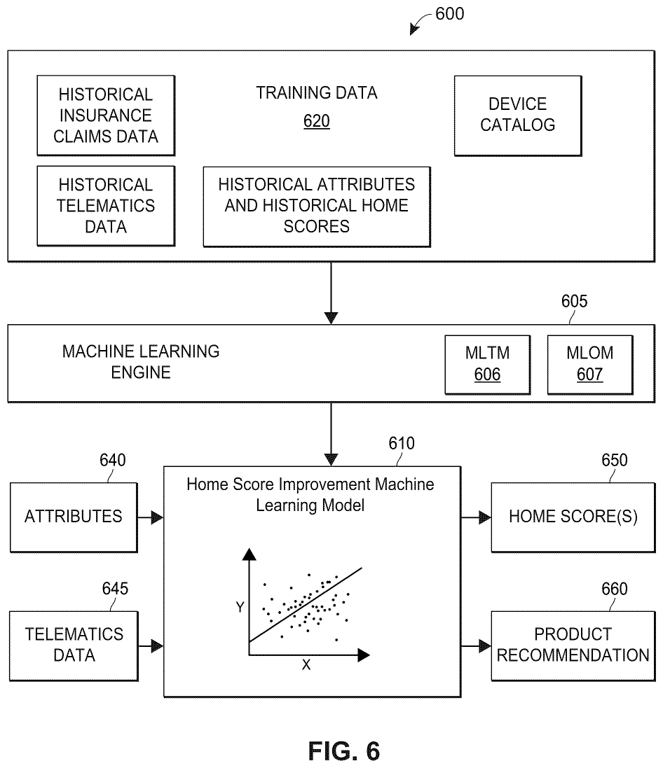

FIG. 6 depicts an exemplary diagram 600 schematically illustrating how an ML model may be trained and used to determine home score(s) based upon attributes (e.g., property attributes, safety attributes, weather attributes, connectivity attributes, and/or property insurance coverage attributes). It should be understood that one ML algorithm may calculate all of the home scores, or different ML algorithms may calculate each of the home scores individually. In some embodiments, ML algorithms calculate one or more of the subscores, and then the subscores are combined (e.g., by averaging, or taking a weighted average of the subscores, etc.).

The exemplary diagram 600 further illustrates how an ML algorithm may be used to generate product recommendations 660, for example, devices that are recommended for the homeowner to purchase, such as devices that will improve the home score(s). In some examples, the product recommendation 660 comprises an insurance product. For example, the product may be a homeowners insurance policy, a renters insurance policy, a personal articles insurance policy, an umbrella insurance policy, etc.

Some of the blocks in FIG. 6 represent hardware and/or software components (e.g., block 605), other blocks represent data structures or memory storing these data structures, registers, or state variables (e.g., block 620), and other blocks represent output data (e.g., blocks 650, 660). Input signals are represented by arrows labeled with corresponding signal names.

The ML engine 605 may include one or more hardware and/or software components, such as the ML training module (MLTM) 606 and/or the ML operation module (MLOM) 607, to obtain, create, (re) train, operate and/or save one or more ML models 610. To generate the ML model 610, the ML engine 605 may use the training data 620.

As described herein, the server such as request server 140 may obtain and/or have available various types of training data 620 (e.g., stored on database of server 140). In one aspect, the training data 620 may labeled to aid in training, retraining and/or fine-tuning the ML model 610. The training data 620 may include data associated with historical insurance claims which may indicate one or more of a type of loss, amount of loss, devices present or absent in the structure, and/or a type of structure. For example, the historical insurance claims data may indicate that a two-story, 2600 sq. ft home with no security system was burglarized.

The training data 620 may include a catalog of devices. The device catalog may include any type of device, such as smoke detectors, carbon monoxide detectors, water leak sensors, motion detectors, security cameras, floodlights, smart locks, door and/or window open/close sensors, alarm systems, etc. The device catalog may include prices, ratings, features, and/or any other suitable information about the devices. The device catalog may include images the devices. The device catalog may include information about new devices for sale and/or older devices no longer for sale. An ML model may process this type of training data 620 to “learn” how to determine the home score(s) 650 and/or the product recommendations 660.

The training data 620 may include historical attributes (e.g., historical property attributes, historical safety attributes, historical weather attributes, historical connectivity attributes, and/or historical property insurance cover coverage attributes) and/or historical home score(s) (e.g., corresponding to the historical attributes).

The training data 620 may further include historical telematics data (e.g., historical telematics data corresponding to any of the telematics data discussed herein, such as discussed with respect to telematics data 192, and/or home telematics data 196).

While the example training data includes indications of various types of training data 620, this is merely an example for case of illustration only. The training data 620 may include any suitable data which may indicate associations between historical claims data, potential sources of loss, devices for mitigating the risk of loss, home scores, home score improvements, as well as any other suitable data which may train the ML model 610 to generate home score(s).

In an aspect, the server may continuously update the training data 620, e.g., based upon obtaining additional historical insurance claims data, additional devices, or any other training data. Subsequently, the ML model 610 may be retrained/fine-tuned based upon the updated training data 620. Accordingly, the home score determinations 650, and/or product recommendations 660 may improve over time.

In one aspect, the ML engine 605 may process and/or analyze the training data 620 (e.g., via MLTM 606) to train the ML model 610 to generate the home score(s). The ML model 610 may be trained to generate the home score(s) via a neural network, deep learning model, Transformer-based model, generative pretrained transformer (GPT), generative adversarial network (GAN), regression model, k-nearest neighbor algorithm, support vector regression algorithm, and/or random forest algorithm, although any type of applicable ML model/algorithm may be used, including training using one or more of supervised learning, unsupervised learning, semi-supervised learning, and/or reinforcement learning.

Once trained, the ML model 610 may perform operations on one or more data inputs to produce a desired data output. In one aspect, the ML model 610 may be loaded at runtime (e.g., by MLOM 607) from a database (e.g., database of server 140) to process the attributes 640. The server, such as server 140, may obtain the attributes 640 and/or telematics data 645 (e.g., telematics data, 192 home telematics data 196, etc.) and use them as input to determine the home score(s) 650, and/or product recommendations 660.

In one aspect, the server may obtain the attributes 640 via user input on a user device, such as the mobile device 112 (e.g., of the property owner) which may be running a mobile app and/or via a website, the chatbot 145, or any other suitable user device. The server may obtain the attributes 640 from available data associated with the structure, such as: government databases of land/property records; a business such as a real estate company which may have publicly listed the property for sale including attributes 640; an insurance company which may have insured the structure and gathered relevant attributes 640 in the process; and/or any other suitable source.

The attributes 640 may include, for example, property attributes, safety attributes, weather attributes, connectivity attributes, and or property insurance coverage subscore attributes. Such attributes are discussed elsewhere herein (e.g., with respect to FIG. 4, etc.).

Once the home score(s) 650 and/or product recommendations 660 are generated by the ML model 610, they may be provided to a user device (e.g., mobile device 112, etc.). For example, the server may provide the home score(s) via a mobile app to mobile device, such as mobile device 112, in an email, a website, via a chatbot (such as the ML chatbot 145), and/or in any other suitable manner as further described herein.

In some embodiments, regardless of whether the subscores are calculated with the use of ML or not, the subscores may be weighted as part of the determination of the overall home score. In some such examples, the weights may be set based upon the type(s) of telematics data and/or attributes received. For example, if the user consents to provide the smart home data from any or all of the smart home devices in the home, the weight for the connectivity subscore may be increased relative to the other weights. In another example, if the user provides the age of the home and/or other information of the home (e.g., types of insulation used in the home etc.), the weight of the property attributes may be increased relative the other weights. Advantageously, setting the weights based upon the type of telematics data and/or attributes received increases the accuracy of the determination of the overall home score. For example, the overall home score is more accurate/reliable because less weight is given to factors that are unknown.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary Training of the ML Chatbot Model

In some embodiments, the chatbot 145 may converse with the user. For example, the chatbot 145 may explain how any of the home score(s) were determined. In another example, the chatbot 145 may provide the product recommendations (e.g., product recommendations 660), and/or explain why a recommended device improves a home score(s).

In certain embodiments, the machine learning chatbot 145 may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT. The machine learning chatbot may be configured to generate verbal, audible, visual, graphic, text, or textual output for either human or other bot/machine consumption or dialogue.

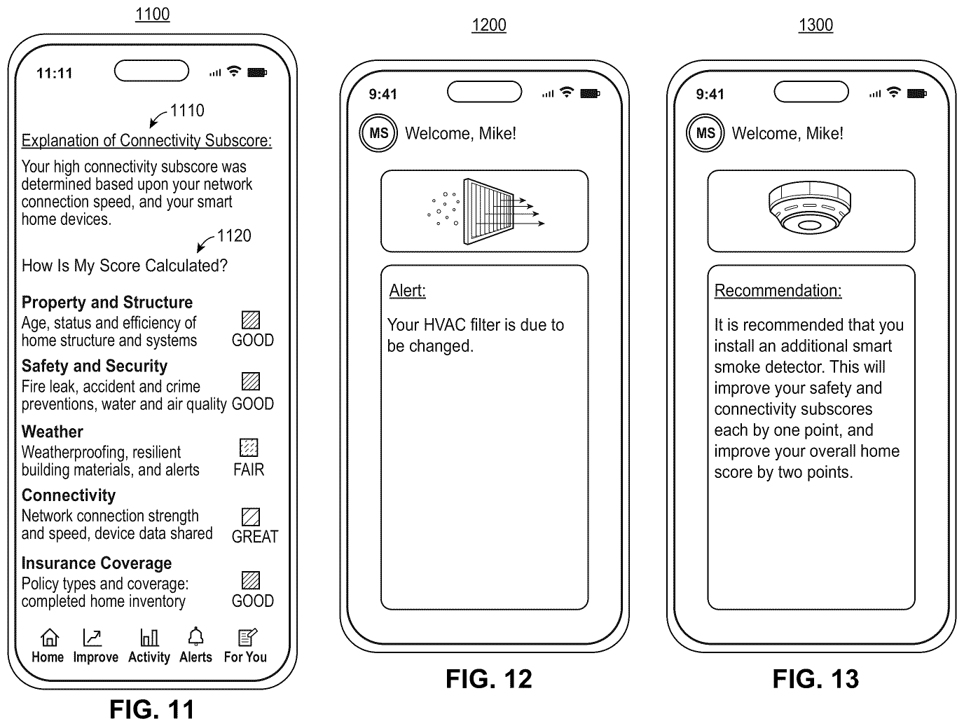

Broadly speaking, the chatbot 145 may be trained to provide questions and/or statements (e.g., blocks 716 and/or 726), provide explanations on how home scores were determined, provide recommendations for devices to purchase to improve the home scores, converse with users, etc. Examples of text generated by the chatbot 145 are illustrated, for example, in FIG. 11 and FIG. 13.

In some embodiments, the chatbot 145 may be trained and/or operated by the request server 140 and/or the mobile device 112 and/or any other suitable component. In certain embodiments, the chatbot 145 is trained by the request server 140, and operated by the mobile device 112.

Programmable chatbots, such the chatbot 145, may provide tailored, conversational-like abilities relevant to recommending upgrades and/or services. The chatbot 145 may be capable of understanding user requests/responses, providing relevant information, etc. Additionally, the chatbot 145 may generate data from user interactions which the enterprise may use to personalize future support and/or improve the chatbot's functionality, e.g., when retraining and/or fine-tuning the chatbot.

In some embodiments, the chatbot 145 comprises an ML chatbot. The ML chatbot may provide advanced features as compared to a non-ML chatbot, which may include and/or derive functionality from a large language model (LLM). The ML chatbot may be trained on a server, such as server 140, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances and/or prompts, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in a memory of the server 140) that may be required for immediate use and may keep track of the current state of the conversation and/or to understand the user's latest input in order to generate an appropriate response. Long-term memory may include persistent storage of information (e.g., on a database of the server 140) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., the server 140) which may be used by the ML chatbot, may consist of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

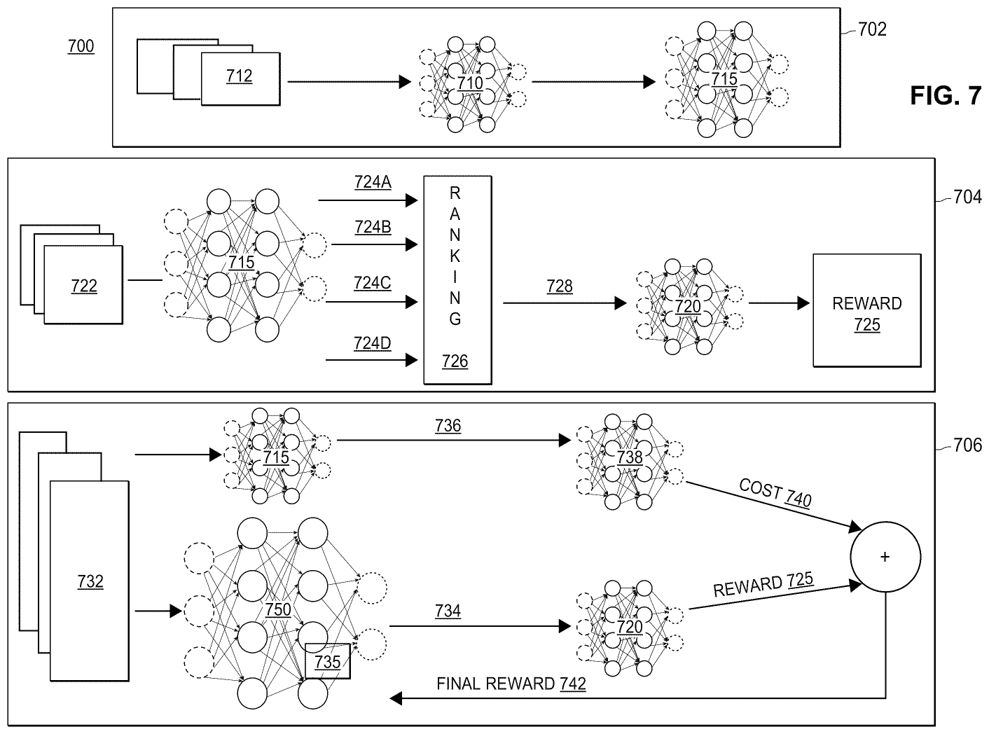

FIG. 7 depicts a combined block and logic diagram 700 for training an ML chatbot model, in which the techniques described herein may be implemented, according to some embodiments. Some of the blocks in FIG. 7 may represent hardware and/or software components, other blocks may represent data structures or memory storing these data structures, registers, or state variables (e.g., data structures for training data 712), and other blocks may represent output data (e.g., 725). Input and/or output signals may be represented by arrows labeled with corresponding signal names and/or other identifiers. The methods and systems may include one or more servers 702, 704, 706, such as the server 140 of FIG. 1.

In one aspect, the server 702 may fine-tune a pretrained language model 710. The pretrained language model 710 may be obtained by the server 702 and be stored in a memory (e.g., a memory of the server). The pretrained language model 710 may be loaded into an ML training module, such as an MLTM (e.g., MLTM 606, etc.), by the server 702 for retraining/fine-tuning. A supervised training dataset 712 may be used to fine-tune the pretrained language model 710 wherein each data input prompt to the pretrained language model 710 may have a known output response for the pretrained language model 710 to learn from. The supervised training dataset 712 may be stored in a memory of the server 702. In one aspect, the data labelers may create the supervised training dataset 712 prompts and appropriate responses. The pretrained language model 710 may be fine-tuned using the supervised training dataset 712 resulting in the SFT ML model 715 which may provide appropriate responses to user prompts once trained. The trained SFT ML model 715 may be stored in a memory of the server 702.

In one aspect, the supervised training dataset 712 may include prompts and responses which may be relevant to determining text explaining how the home scores were determined, and/or explaining product recommendations. For example, a user prompt may include an inquiry as to how a home score was determined. Appropriate responses from the trained SFT ML model 715 may include an explanation of how the home score was determined, etc. The responses may be via text, audio, multimedia, etc.

### Training the Reward Model

In one aspect, training the ML chatbot model 750 may include the server 704 training a reward model 720 to provide as an output a scaler value/reward 725. The reward model 720 may be required to leverage Reinforcement Learning with Human Feedback (RLHF) in which a model (e.g., ML chatbot model 750) learns to produce outputs which maximize its reward 725, and in doing so may provide responses which are better aligned to user prompts.

Training the reward model 720 may include the server 704 providing a single prompt 722 to the SFT ML model 715 as an input. The input prompt 722 may be provided via an input device (e.g., a keyboard) via the I/O module of the server 140. The prompt 722 may be previously unknown to the SFT ML model 715, e.g., the labelers may generate new prompt data, the prompt 722 may include testing data stored on database, and/or any other suitable prompt data. The SFT ML model 715 may generate multiple, different output responses 724A, 724B, 724C, 724D to the single prompt 722. The server 704 may output the responses 724A, 724B, 724C, 724D via an I/O module to a user interface device, such as a display (e.g., as text responses), a speaker (e.g., as audio/voice responses), and/or any other suitable manner of output of the responses 724A, 724B, 724C, 724D for review by the data labelers.

The data labelers may provide feedback via the server 704 on the responses 724A, 724B, 724C, 724D when ranking 726 them from best to worst based upon the prompt-response pairs. The data labelers may rank 726 the responses 724A, 724B, 724C, 724D by labeling the associated data. The ranked prompt-response pairs 728 may be used to train the reward model 720. In one aspect, the server 704 may load the reward model 720 via the MTLM 606 module and train the reward model 720 using the ranked response pairs 728 as input. The reward model 720 may provide as an output the scalar reward 725.

In one aspect, the scalar reward 725 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 720 may generate a winning reward. Inputting a “losing” prompt-response pair data to the same reward model 720 may generate a losing reward. The reward model 720 and/or scalar reward 736 may be updated based upon labelers ranking 726 additional prompt-response pairs generated in response to additional prompts 722.

In one example, a data labeler may provide to the SFT ML model 715 as an input prompt 722, “Describe the sky.” The input may be provided by the labeler via the server 704 running a chatbot application utilizing the SFT ML model 715. The SFT ML model 715 may provide as output responses to the labeler via the server 704: (i) “the sky is above” 724A; (ii) “the sky includes the atmosphere and may be considered a place between the ground and outer space” 724B; and (iii) “the sky is heavenly” 724C. The data labeler may rank 726, via labeling the prompt-response pairs, prompt-response pair 722/724B as the most preferred answer; prompt-response pair 722/724A as a less preferred answer; and prompt-response 722/724C as the least preferred answer. The labeler may rank 726 the prompt-response pair data in any suitable manner. The ranked prompt-response pairs 728 may be provided to the reward model 720 to generate the scalar reward 725.

While the reward model 720 may provide the scalar reward 725 as an output, the reward model 720 may not generate a response (e.g., text). Rather, the scalar reward 725 may be used by a version of the SFT ML model 715 to generate more accurate responses to prompts, i.e., the SFT model 715 may generate the response such as text to the prompt, and the reward model 720 may receive the response to generate a scalar reward 725 of how well humans perceive it. Reinforcement learning may optimize the SFT model 715 with respect to the reward model 720 which may realize the configured ML chatbot model 750.

### RLHF to Train the ML Chatbot Model

In one aspect, the server 706 may train the ML chatbot model 750 (e.g., via the MLTM 606) to generate a response 734 to a random, new and/or previously unknown user prompt 732. To generate the response 734, the ML chatbot model 750 may use a policy 735 (e.g., algorithm) which it learns during training of the reward model 720, and in doing so may advance from the SFT model 715 to the ML chatbot model 750. The policy 735 may represent a strategy that the ML chatbot model 750 learns to maximize its reward 725. As discussed herein, based upon prompt-response pairs, a human labeler may continuously provide feedback to assist in determining how well the ML chatbot's 750 responses match expected responses to determine rewards 725. The rewards 725 may feed back into the ML chatbot model 750 to evolve the policy 735. Thus, the policy 735 may adjust the parameters of the ML chatbot model 750 based upon the rewards 725 it receives for generating good responses. The policy 735 may update as the ML chatbot model 750 provides responses 734 to additional prompts 732.

In one aspect, the response 734 of the ML chatbot model 750 using the policy 735 based upon the reward 725 may be compared using a cost function 738 to the SFT ML model 715 (which may not use a policy) response 736 of the same prompt 732. The server 706 may compute a cost 740 based upon the cost function 738 of the responses 734, 736. The cost 740 may reduce the distance between the responses 734, 736, i.e., a statistical distance measuring how one probability distribution is different from a second, in one aspect the response 734 of the ML chatbot model 750 versus the response 736 of the SFT model 715. Using the cost 740 to reduce the distance between the responses 734, 736 may avoid a server over-optimizing the reward model 720 and deviating too drastically from the human-intended/preferred response. Without the cost 740, the ML chatbot model 750 optimizations may result in generating responses 734 which are unreasonable but may still result in the reward model 720 outputting a high reward 725.

In one aspect, the responses 734 of the ML chatbot model 750 using the current policy 735 may be passed by the server 706 to the rewards model 720, which may return the scalar reward or discount 725. The ML chatbot model 750 response 734 may be compared via cost function 738 to the SFT ML model 715 response 736 by the server 706 to compute the cost 740. The server 706 may generate a final reward 742 which may include the scalar reward 725 offset and/or restricted by the cost 740. The final reward or discount 742 may be provided by the server 706 to the ML chatbot model 750 and may update the policy 735, which in turn may improve the functionality of the ML chatbot model 750.

To optimize the ML chatbot model 750 over time, RLHF via the human labeler feedback may continue ranking 726 responses of the ML chatbot model 750 versus outputs of earlier/other versions of the SFT ML model 715, i.e., providing positive or negative rewards or adjustments 725. The RLHF may allow the servers (e.g., servers 704, 706) to continue iteratively updating the reward model 720 and/or the policy 735. As a result, the ML chatbot model 750 may be retrained and/or fine-tuned based upon the human feedback via the RLHF process, and throughout continuing conversations may become increasingly efficient.

Although multiple servers 702, 704, 706 are depicted in the exemplary block and logic diagram 700, each providing one of the three steps of the overall ML chatbot model 750 training, fewer and/or additional servers may be utilized and/or may provide the one or more steps of the ML chatbot model 750 training. In one aspect, one server may provide the entire ML chatbot model 750 training.

Exemplary Computer-Implemented Method for Generating and/or Displaying Home Scores for a Property

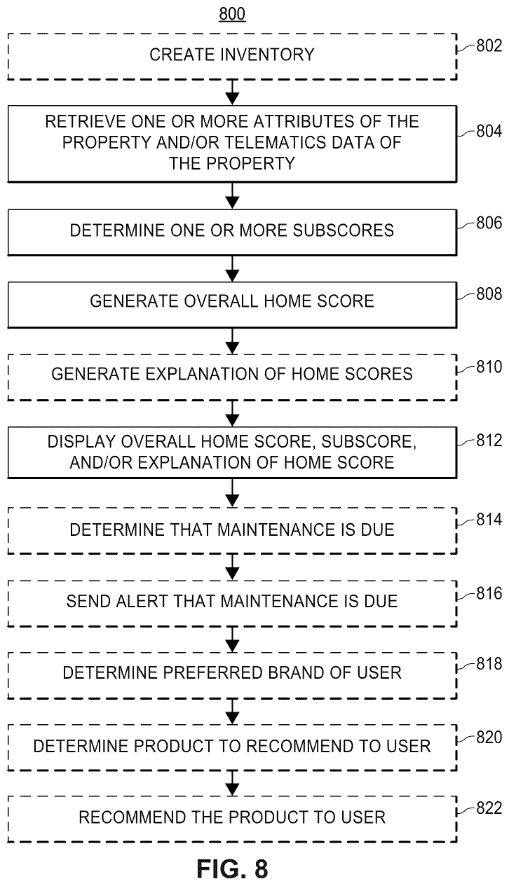

FIG. 8 illustrates a flow diagram representing an exemplary computer-implemented method or implementation 800 for generating and/or displaying home scores for a property. The exemplary method 800 may be implemented by any suitable device including those discussed elsewhere herein, such as one or more local or remote processors, transceivers, memory units, sensors, mobile devices, unmanned aerial vehicles (e.g., drones), etc. For example, although the following discussion refers to many of the blocks as being performed by the one or more processors 142, the blocks may be performed by any suitable component(s), such as the one or more processors 122 the one or more processors 150, etc.

The exemplary computer-implemented method or implementation 800 may begin at optional block 802 when the one or more processors 142 create an inventory. The inventory may be created by any suitable technique. In some examples, the inventory is created by presenting the user with room-by-room checklists of items to add to the inventory. For example, the user may first be presented with a checklist of items to add from a dining room (e.g., antiques, silverware, china, a smoke detector, etc.), then presented with a checklist of items to add from a kitchen (e.g., a refrigerator, a stove, a microwave, a dishwasher, a smoke detector, etc.), then presented with a checklist of items to add from a bedroom (e.g., antiques, jewelry, furniture, a mattress, a smoke detector, etc.).

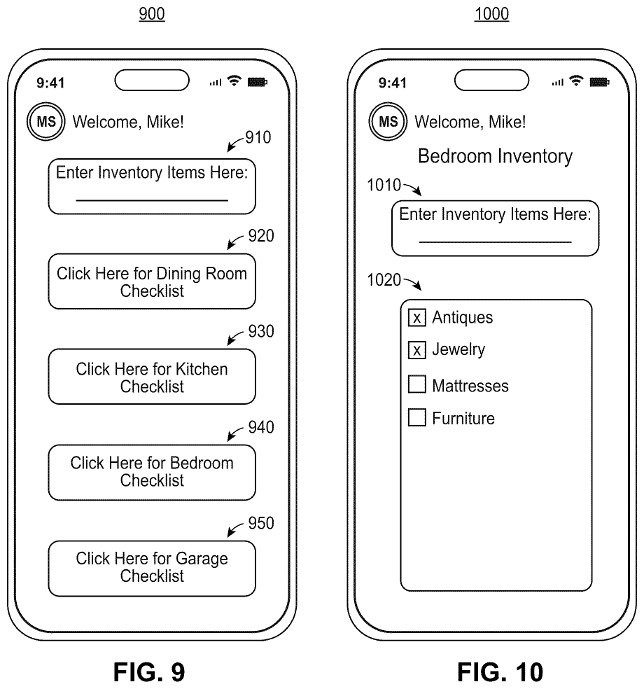

FIG. 9 depicts an exemplary screen 900 enabling a user to view checklists of different rooms. More specifically, screen 900 allows the user to enter inventory items into box 910, and further allows the user to click on buttons 920, 930, 940, 950 to view checklists for different rooms. For example, clicking on button 940 may bring the user to exemplary screen 1000 of FIG. 10. Exemplary screen 1000 depicts checklist 1020 of potential bedroom inventory items to add to the home inventory. The exemplary screen 1000 further allows the user to enter the inventory items into box 1010.

At block 804, the one or more processors 142 may retrieve one or more attributes of the property and/or telematics data of the property 116. The one or more attributes of the property and/or telematics data of the property 116 may be retrieved from any suitable source, such as any component shown in FIG. 1, such as the mobile device 112, the smart product 110, the request server 140, the weather database 199, the external database 198, the requester 114, the vendor 182, the security company 180, etc.

In some embodiments, the one or more attributes comprise property attributes, safety attributes, weather attributes, connectivity attributes, and/or property insurance coverage attributes. In some examples, the attributes may be assigned grades/values, as in the example of FIG. 4. The attributes are described elsewhere herein.

Examples of the telematics data 192, 196 are described with respect to FIG. 1.

At block 806, the one or more processors 142 may determine one or more subscores. For example, the property subscore, the safety subscore, the weather subscore, the connectivity subscore, and/or the property insurance coverage subscore may be determined. The determination of the subscores is described elsewhere herein.

At block 808, the overall home score may be generated (e.g., as described elsewhere herein and/or based upon the subscores).

At optional block 810, the one or more processors 142 generate an explanation of one or more of the home scores (e.g., via the chatbot 145). For example, the explanation may state, “your high safety subscore was calculated based upon that your home is located near a fire station, has a strong security system installed, and has no trees overhanging it.” In another example, the explanation may state, “your high weather subscore was based upon that your home has two sump pumps with backup batteries installed, is built with high-quality building materials, and has a weather alert system installed.”

At block 812, the overall home score, the subscores, and/or the explanation may be displayed (e.g., as shown in the examples of FIG. 3, FIG. 11, etc.).

FIG. 11 depicts an exemplary screen 1100 including an exemplary explanation of the connectivity subscore 1110. The exemplary screen 1100 further includes options 1120 enabling a user to choose to view explanations of the different subscores.

In some examples, the displaying includes displaying indications of home subscores comprising color-coded indications of the home subscores. For example, displaying the overall home score 310 in green may indicate a higher overall home score returned; displaying the overall home score 310 in yellow may indicate the medium-range overall home score 310; and displaying the overall home score 310 in red may indicate a poor overall home score 310.

At optional block 814, the one or more processors 142 may determine that maintenance is due. For example, it may be determined that the battery on a particular device (e.g., a smoke detector, etc.) should be replaced. For instance, a smart device (e.g., a smart smoke detector) may send a signal to the one or more processors 142 (or any other component, such as a smart home hub, etc.) indicating that a battery is running low, etc. In another example, the one or more processors 142 may determine that the battery should be replaced based upon a time that the device has been operating (e.g., battery on a particular devices known to last 6 months, so it is determined that the battery should be replaced slightly before the 6-month time period is up).

In some examples, the maintenance may be replacement of a part that should be replaced at periodic intervals. For example, the maintenance may be to replace a heating, ventilation, and air conditioning (HVAC) filter at a prespecified time interval (e.g., one month, two months, six months, etc.).

At optional block 816, the one or more processors 142 send an alert that the maintenance is due. For example, the alert may be a visual alert at the mobile device 112, such as in the exemplary screen 1200 of FIG. 12, which shows an alert that the HVAC filter is due to be changed. Additionally or alternatively, the alert may be auditory and/or haptic.

At optional block 818, the one or more processors 142 determine the preferred brand of the user. The preferred brand may be determined by any suitable technique. For example, the preferred brand may be determined to be a brand that the user owns the most items of. Additionally or alternatively, the preferred brand may be determined to be a brand that the user has made recent purchases of (e.g., purchases during a particular time period etc.).

At optional block 820, the one or more processors 142 may determine a product of the preferred brand that will improve the overall home score. The product may be determined by any suitable technique. For example, the one or more processors 142 may start with a catalog of products of the preferred brand. The one or more processors 142 may then calculate the subscores and/or overall home score with and without products from the catalog added to the home. The product may then be determined by comparing the calculated subscores and/or overall home scores.

In other examples, the one or more processors 142 access the catalog of devices of the preferred brand, and the catalog of devices includes numbers for each device for how much each device will improve the subscores and/or overall home score.

In some examples, the product is an insurance product. For example, the product may be a homeowners insurance policy, a renters insurance policy, a personal articles insurance policy, an umbrella insurance policy, etc.

At optional block 822, the one or more processors 142 recommend the determined product to the user. The recommendation may be presented to the user via any suitable technique. For example, the recommendation may be presented at the mobile device 112, as illustrated by the exemplary screen 1300 of the example of FIG. 13.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for generating and/or displaying home scores for a property may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) retrieving, by one or more processors, one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determining, by the one or more processors, one or more home subscores, wherein the one or more home subscores include (i) a property subscore, (ii) a safety subscore, (iii) a weather subscore, (iv) a connectivity subscore, and/or (v) a property insurance coverage subscore, and wherein the determining the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generating, by the one or more processors, the overall home score of the property based upon the one or more subscores; and/or (4) displaying, via the one or more processors: (i) one or more of the home subscores, and (ii) the overall home score. The method may include additional, fewer, or alternate actions, including those discussed elsewhere herein.

In some embodiments, the determining the one or more home subscores includes determining the property subscore based upon the one or more property attributes, and/or wherein the one or more property attributes comprise a property age attribute, a status of property structure attribute, an efficiency of property structure attribute, a status of property systems attribute, and/or an efficiency of property systems attribute.

In some embodiments, the determining the one or more home subscores includes determining the safety subscore based upon the one or more safety attributes, and/or wherein the one or more safety attributes comprise a fire protection attribute, a burglary protection attribute, a water quality attribute, a tree overhang attribute, and/or an air quality attribute.

In some embodiments, the determining the one or more home subscores includes determining the weather subscore based upon the one or more weather attributes, and/or wherein the one or more weather attributes comprise a property weatherproofing attribute, a presence of resilient building materials attribute, and/or a presence of property weather alert systems attribute.

In some embodiments, the determining the one or more home subscores includes determining the connectivity subscore based upon the one or more connectivity attributes, and/or wherein the one or more connectivity attributes comprise a property network connection strength attribute, a property network connection speed attribute, and/or a smart home devices on the property network attribute.

In some embodiments, the determining the one or more home subscores includes determining the property insurance coverage subscore based upon the one or more property insurance coverage attributes, and/or wherein the one or more property insurance coverage attributes comprise attributes of: property insurance policy types associated with the property, an insurance coverage amount associated with the property, insurance deductible amounts associated with the property, and/or a home inventory associated with the property.

In some embodiments, the one or more property insurance coverage attributes comprise the home inventory, and/or wherein the method further comprises creating the home inventory by: presenting, via the one or more processors, a first checklist of items for a first room; in response to the presenting the first checklist, receiving, via the one or more processors, a first list of items for the first room; presenting, via the one or more processors, a second checklist of items for a second room; in response to the presenting the second checklist, receiving, via the one or more processors, a second list of items for the second room; and/or adding the first list of items to the second list of items.

In some embodiments, the displaying includes displaying indications of home subscores comprising color-coded indications of the home subscores.

In some embodiments, the displaying includes displaying an indication of the overall home score as a color-coded indication of the overall home score.

In some embodiments, the retrieving comprises retrieving the one or more attributes of a property from an external database and/or a mobile device associated with the property.

In some embodiments, the method further includes: training, via the one or more processors, a machine learning algorithm based upon: (i) historical attributes of historical properties, (ii) historical home scores, and/or (iii) the historical insurance claims data; and/or wherein the determining the one or more home scores comprises inputting: (i) the one or more property attributes, (ii) the one or more safety attributes, (iii) the one or more weather attributes, (iv) the one or more connectivity attributes, and/or (v) the property insurance coverage attributes into the trained machine learning algorithm to determine the one or more home scores.

In some embodiments, the method further includes, via the one or more processors, a particular type of telematics data; and/or wherein the generating the overall home score comprises weighting at least one of the subscores based upon the particular type of telematics data.

In some embodiments, the method further includes: determining, via the one or more processors, that maintenance is due for the property; and/or in response to the determining that the maintenance is due for the property, displaying, via the one or more processors, an alert that the maintenance is due.

In some embodiments, the method further includes: determining, via the one or more processors, a preferred brand of a user associated with the property; determining, via the one or more processors, a product of the determined preferred brand that will improve the overall home score; and/or recommending, via the one or more processors, the product to the user.

In another aspect, a computer system for generating and/or displaying home scores for a property may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer system may include one or more processors configured to: (1) retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generate the overall home score of the property based upon the one or more subscores; and/or (4) display: (i) one or more of the home subscores, and (ii) the overall home score. The computer system may include additional, less, or alternate functionality, including that discussed elsewhere herein.

In some embodiments, the one or more processors are configured to display the one or more of the home subscores by displaying indications of home subscores comprising color-coded indications of the home subscores.

In some embodiments, the one or more processors are configured to display an indication of the overall home score as a color-coded indication of the overall home score.

In some embodiments, the one or more processors are further configured to retrieve the one or more attributes of a property by retrieving the one or more attributes of the property from an external database and/or a mobile device associated with the property.

In yet another aspect, a tangible, non-transitory computer-readable medium storing instructions for generating and/or displaying home scores may be provided. The instructions, when executed by one or more processors of a computing device, may cause the computing device to perform certain actions. The computing device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the tangible, non-transitory computer-readable medium may store instructions that, when executed by one or more processors of a computing device, cause the computing device to: (1) retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes; (2) determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one or more home score factors comprises determining: the property subscore based upon the one or more property attributes; the safety subscore based upon the one or more safety attributes; the weather subscore based upon the one or more weather attributes; the connectivity subscore based upon the one or more connectivity attributes; and/or the property insurance coverage subscore based upon the one or more property insurance coverage attributes; (3) generate the overall home score of the property based upon the one or more subscores; and/or (4) display: (i) one or more of the home subscores, and (ii) the overall home score. The tangible, non-transitory computer-readable medium may include additional, less, or alternate functionality, including that discussed elsewhere herein.

In some embodiments, the non-transitory computer-readable medium further includes instructions that, when executed by the one or more processors, cause the computing device to display the one or more of the home subscores by displaying indications of home subscores comprising color-coded indications of the home subscores.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generating and/or displaying home scores for a property, the computer-implemented method comprising:
retrieving, by one or more processors, one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes;
determining, by the one or more processors, one or more home subscores, wherein the one or more home subscores include (i) a property subscore, (ii) a safety subscore, (iii) a weather subscore, (iv) a connectivity subscore, and/or (v) a property insurance coverage subscore, and wherein the determining the one or more home score factors comprises determining:
the property subscore based upon the one or more property attributes;
the safety subscore based upon the one or more safety attributes;
the weather subscore based upon the one or more weather attributes;
the connectivity subscore based upon the one or more connectivity attributes;
and/or
the property insurance coverage subscore based upon the one or more property insurance coverage attributes;
generating, by the one or more processors, the overall home score of the property based upon the one or more subscores; and
displaying, via the one or more processors: (i) one or more of the home subscores, and (ii) the overall home score.

2. The computer-implemented method of claim 1, wherein the determining the one or more home subscores comprises determining the property subscore based upon the one or more property attributes, and wherein the one or more property attributes comprise a property age attribute, a status of property structure attribute, an efficiency of property structure attribute, a status of property systems attribute, and/or an efficiency of property systems attribute.

3. The computer-implemented method of claim 1, wherein the determining the one or more home subscores comprises determining the safety subscore based upon the one or more safety attributes, and wherein the one or more safety attributes comprise a fire protection attribute, a burglary protection attribute, a water quality attribute, a tree overhang attribute, and/or an air quality attribute.

4. The computer-implemented method of claim 1, wherein the determining the one or more home subscores comprises determining the weather subscore based upon the one or more weather attributes, and wherein the one or more weather attributes comprise a property weatherproofing attribute, a presence of resilient building materials attribute, and/or a presence of property weather alert systems attribute.

5. The computer-implemented method of claim 1, wherein the determining the one or more home subscores comprises determining the connectivity subscore based upon the one or more connectivity attributes, and wherein the one or more connectivity attributes comprise a property network connection strength attribute, a property network connection speed attribute, and/or a smart home devices on the property network attribute.

6. The computer-implemented method of claim 1, wherein the determining the one or more home subscores comprises determining the property insurance coverage subscore based upon the one or more property insurance coverage attributes, and wherein the one or more property insurance coverage attributes comprise attributes of: property insurance policy types associated with the property, an insurance coverage amount associated with the property, insurance deductible amounts associated with the property, and/or a home inventory associated with the property.

7. The computer-implemented method of claim 6, wherein the one or more property insurance coverage attributes comprise the home inventory, and wherein the method further comprises creating the home inventory by:
presenting, via the one or more processors, a first checklist of items for a first room;
in response to the presenting the first checklist, receiving, via the one or more processors, a first list of items for the first room;
presenting, via the one or more processors, a second checklist of items for a second room;
in response to the presenting the second checklist, receiving, via the one or more processors, a second list of items for the second room; and
adding the first list of items to the second list of items.

8. The computer-implemented method of claim 1, wherein the displaying includes displaying indications of home subscores comprising color-coded indications of the home subscores.

9. The computer-implemented method of claim 1, wherein the displaying includes displaying an indication of the overall home score as a color-coded indication of the overall home score.

10. The computer-implemented method of claim 1, wherein the retrieving comprises retrieving the one or more attributes of a property from an external database and/or a mobile device associated with the property.

11. The computer-implemented method of claim 1, further comprising:
training, via the one or more processors, a machine learning algorithm based upon: (i) historical attributes of historical properties, (ii) historical home scores, and/or (iii) the historical insurance claims data; and
wherein the determining the one or more home scores comprises inputting: (i) the one or more property attributes, (ii) the one or more safety attributes, (iii) the one or more weather attributes, (iv) the one or more connectivity attributes, and/or (v) the property insurance coverage attributes into the trained machine learning algorithm to determine the one or more home scores.

12. The computer-implemented method of claim 1, further comprising receiving, via the one or more processors, a particular type of telematics data; and
wherein the generating the overall home score comprises weighting at least one of the subscores based upon the particular type of telematics data.

13. The computer-implemented method of claim 1, further comprising:
determining, via the one or more processors, that maintenance is due for the property; and
in response to the determining that the maintenance is due for the property, displaying, via the one or more processors, an alert that the maintenance is due.

14. The computer-implemented method of claim 1, further comprising:
determining, via the one or more processors, a preferred brand of a user associated with the property;
determining, via the one or more processors, a product of the determined preferred brand that will improve the overall home score; and
recommending, via the one or more processors, the product to the user.

15. A computer system for generating and/or displaying home scores for a property, the computer system comprising one or more processors configured to:
retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes;
determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one
or more home score factors comprises determining:
the property subscore based upon the one or more property attributes;
the safety subscore based upon the one or more safety attributes;
the weather subscore based upon the one or more weather attributes;
the connectivity subscore based upon the one or more connectivity attributes;
and/or
the property insurance coverage subscore based upon the one or more property insurance coverage attributes;
generate the overall home score of the property based upon the one or more subscores; and
display: (i) one or more of the home subscores, and (ii) the overall home score.

16. The computer system of claim 15, wherein the one or more processors are configured to display the one or more of the home subscores by displaying indications of home subscores comprising color-coded indications of the home subscores.

17. The computer system of claim 15, wherein the one or more processors are configured to display an indication of the overall home score as a color-coded indication of the overall home score.

18. The computer system of claim 15, wherein the one or more processors are further configured to retrieve the one or more attributes of a property by retrieving the one or more attributes of the property from an external database and/or a mobile device associated with the property.

19. A tangible, non-transitory computer-readable medium storing instructions for generating and/or displaying home scores for a property that, when executed by one or more processors of a computing device, cause the computing device to:
retrieve one or more attributes of the property, the one or more attributes comprising: (i) one or more property attributes, (ii) one or more safety attributes, (iii) one or more weather attributes, (iv) one or more connectivity attributes, and/or (v) one or more property insurance coverage attributes;
determine one or more home subscores, wherein the one or more home subscores include (i) a property subscore, (ii) a safety subscore, (iii) a weather subscore, (iv) a connectivity subscore, and/or (v) a property insurance coverage subscore, and wherein the determine the one or more home score factors comprises determining:
the property subscore based upon the one or more property attributes;
the safety subscore based upon the one or more safety attributes;
the weather subscore based upon the one or more weather attributes;
the connectivity subscore based upon the one or more connectivity attributes;
and/or
the property insurance coverage subscore based upon the one or more property insurance coverage attributes;
generate the overall home score of the property based upon the one or more subscores; and
display: (i) one or more of the home subscores, and (ii) the overall home score.

20. The tangible, non-transitory computer-readable medium of claim 19, wherein the non-transitory computer-readable medium further includes instructions that, when executed by the one or more processors, cause the computing device to display the one or more of the home subscores by displaying indications of home subscores comprising color-coded indications of the home subscores.
